(19) United States
(12) Patent Application Publication
(10) Pub. No.: US 2025/0209140 A1
(43) Pub. Date: Jun. 26, 2025

(54) BLOCKCHAIN TECHNOLOGY BASED OWNERSHIP DISTRIBUTION METHOD AND SYSTEM

(71) Applicant: Mark Aleksandrovich NECHAEV, Novosibirsk (RU)

(72) Inventor: Faisal Ashfaq Satti Mohammad, Islamabad (PK)

(21) Appl. No.: 18/848,139

(22) PCT Filed: Mar. 21, 2022
(86) PCT No.: PCT/RU2022/050093

§ 371 Date: Sep. 18, 2024

(51) Int. Cl. G06F 21/10; H04L 9/00

(52) U.S. Cl. CPC G06F 21/1014; H04L 9/50

(57) ABSTRACT

Block chain technology based ownership distribution method and system in digital eco system, Is the invention that relates to distribution and sharing of ownership of digital application entity to digital application accounts through block chain technology, where digital application account activity is recorded, calculated and rewarded for making contribution in development and growth of digital application entity and digital application account is awarded with cryptographic ownership tokens (COTs) according to contribution made. The method also contains a dedicated exchange where only cryptographic ownership tokens generated through the proposed method and system are listed and traded.

### CROSS-REFERENCE TO RELATED APPLICATIONS

This application is a national stage application of the Patent Cooperation Treaty (PCT) international application titled “Blockchain Technology Based Ownership Distribution Method And System”, international application number PCT/RU2022/050093, filed in the Russian Patent Office on Mar. 21, 2022. The specification of the above referenced patent application is incorporated herein by reference in its entirety.

### FIELD OF THE INVENTION

This invention, in general, relates to Blockchain Technology. More specifically, this invention relates to distribution and sharing of ownership of digital application entity to digital application accounts through block chain technology, where digital application account contribution is recorded, calculated and rewarded in development and growth of digital application entity and application account is awarded with cryptographic ownership tokens according to contribution made.

### BACKGROUND

The technical solution is known for the international patent for the invention No. US 2012/00895.01 A1, Oct. 10, 2010 Method for Sharing Ownership and Revenue with Customer. The technical solution is characterized by the fact that it refers to a way to share ownership and revenue with the customer by primary business shareholder

The technical solution listed above have a number of disadvantages:

The technical solution under the patent number No. US 2012/00895.01 A1, does not suggest any method of calculation and distribution of profits and revenues to digital application accounts through block chain network system.

The claimed invention, unlike all of the above solutions, is a full-fledged block-chain based ownership distribution method in digital eco system.

### BRIEF DESCRIPTION OF THE DRAWINGS

FIG. 1 illustrates a user's ability to access a digital application through hardware based key cards or hardware.

FIG. 2 illustrates the user accessing a digital application for registration.

FIG. 3 illustrates the user using the digital application, operating under Block chain technology based ownership distribution system and method.

FIG. 4 illustrates a method for ownership distribution over a block chain network to digital accounts linked to digital applications.

FIG. 5 illustrates a public key, a wallet key and a private key generated by a system for ownership distribution over a block chain network to digital accounts linked to digital applications.

FIG. 6 illustrates information a block chain may record related to cryptographic ownership token (COT) may contain, such as Cryptographic ownership Token identifier, Holder Address, Owner/Holder Title, Issue Time Stamp.

FIG. 7 illustrates the block chain network operating under master slave relationship.

FIG. 8 illustrates an exchange operating as a custodian.

FIG. 9 illustrates the exchange operating as a pure non-custodian.

FIG. 10 illustrates the exchange operating as both a custodian and a non-custodian.

FIG. 11 illustrates the proposed percentages and values that may be used by central processing unit or digital application units or any similar processing unit, to distribute profits and earnings.

### DETAILED DESCRIPTION OF THE INVENTION

A block chain may refer to a distributed database. A block chain can be used to maintain a continuously growing list of records called blocks. A block chain can be used to maintain a record of transaction or events between parties in a way that is difficult to falsify. Each block in a block chain may include several records as well as a hash of previous blocks in the block chain. If a record in a previous block is changed, the hash may be disrupted in any following blocks. The result is that in order to falsify a given record, the hacker has to falsify that record and all subsequent records so that the hashes end up the same. This is extremely difficult in practice.

Additionally, a block chain may be distributed among a large number of entities. Any changes to the block chain may be verified by comparing it to the numerous individual records.

A “key” may refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

The term “user” is used to reference the Platform account owner, such as a device, an organization, consumer, group, closed user group, user-agent, Automated agent, corporate or a commercial entity or any authorized entity.

The User may be any form of application user, the buyer, the seller, the service provider, service user.

The term cryptographic ownership tokens (COTs) is used to represent block chain based ownership distribution and those skilled in the art will appreciate that this terminology is only illustrative and does not affect the scope of the invention.

The Block chain technology based ownership distribution method may be implemented to single digital application, Group of digital applications, a single digital system or Platform or multiple digital systems or platforms, the terms may be used interchangeably.

The system may include software designed for collecting and disseminating this information on various media devices, i.e. mobile phones, digital cameras, digital recorders, laptops, personal computers, body gear, ocular viewers, consoles, terminals, tablets, drones and any Internet-ready device.

The platform is comprised of a graphical user interface designed specifically for viewing on mobile and non-mobile computing devices, i.e., mobile phones, laptops, personal computers, body gear, ocular viewers, drones, PDAs, consoles, terminals and tablets. It may also include a full, and always updating, commercial relational or non-relational database engine for the storage of content and user inputted information and user-defined custom preferences and locations.

The platform may include annotation and indexing mechanisms which may simplify the collection, storage and management of activity data elements. The platform may have a universal browser or application based presentation structure that may be scaled and deployed across various hardware resources and networks without a need to retool. It may be implemented on phones, laptops, tablets, optical viewers, body gear, drones, PDAs, consoles, terminals and personal computers by rendering the Software at the non-mobile or mobile computing device level.

In Block chain technology based ownership distribution method in digital eco system, user accesses the digital application for use, user can be the first time user or recurring session based user, The system in proposed method may allow unlimited number of users and usage sessions, A system may represent a single digital application or group of digital applications.

In proposed invention User may be able to access the digital application linked to Block chain technology based ownership distribution method, without registering, subscribing, signing up. But by this User may not be able to get advantage of Block chain technology based ownership distribution method as system may only be able to link activates to digital application accounts or specific machines but may not be able to associate activity to any unknown usage.

Now to get advantage of Block chain technology based ownership distribution method, user usage session must be linked to some digital identity. So, if user is first time user of digital application system and is not registered to the system by any mean, digital application may suggest user of application to register to the system in order to be benefited from Block chain technology based ownership distribution.

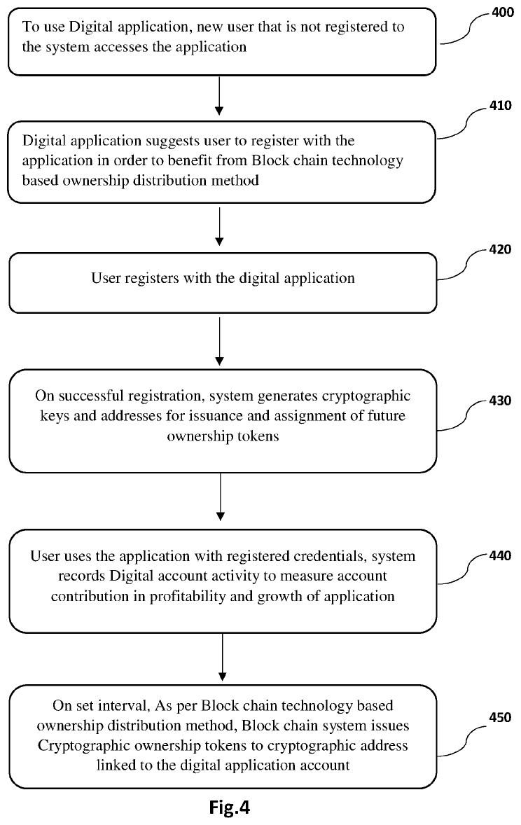

A simple illustration of proposed invention is shown in FIG. 4, Here in this figure it is assumed that user is completely new to the system and is not registered to any of Digital application, linked to the system, operating under Block chain technology based ownership distribution method. When user accesses and uses the digital application, application suggests user to register in order to be benefited from Block chain technology based ownership distribution method 410. In 420 user registers with digital application. And in 430 on successful registration, system generates cryptographic keys and addresses and link them to the registered digital account, 440.

450, User uses the digital application and system records activities of that digital account in order to determine contribution of that digital account in development, growth and profitability of application and there then issues cryptographic ownership tokens (COT) over block chain network to linked account cryptographic address on any set interval.

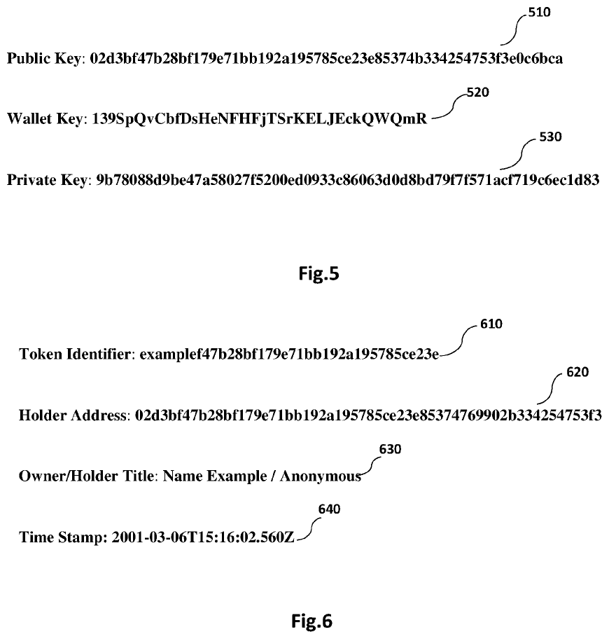

To issue cryptographic ownership tokens, block chain system needs cryptographic address, user may generate cryptographic addresses at the time of registration through any of the application linked to the system, typical Cryptographic addresses generated by the system will have Public key, Wallet key and Private Key, like shown in FIG. 5.

User can generate unlimited number of cryptographic keys and addresses and system may allow user to use third party key generator, but preferably, at particular time of issuance of Cryptographic ownership tokens (COTs), block chain network may only issue cryptographic ownership token belonging to single digital application account to single cryptographic key or address.

User may be able to link multiple addresses to single application account and may guide the system with the proportion of issuances to be made to each address, For example, user linked two different block chain addresses to digital application account and guide the system to issue 50% of cryptographic ownership tokens to one account and 50% to another. Like shown in FIG. 6, the information a block chain may record related to cryptographic ownership token (COT) may contain, Cryptographic ownership Token identifier, Holder Address, Owner/Holder Title, Issue Time Stamp.

(610) Token identifier, is the unique identity of every cryptographic ownership token (COT) that is generated and assigned to every ownership token by block chain system. This token identifier is unique immutable cryptographic hash.

(620) Holder Address is the address that represents the public address that is currently holding the cryptographic ownership token, This address is assigned by the block chain system to cryptographic ownership token on initial issuance and later block chain system updates this address on every transfer to new cryptographic public address.

(630) Owner/Holder Title is the Name or any pseudonym that user provides to the system to be attached and displayed with the token. As per preference, User may keep it anonymous or empty.

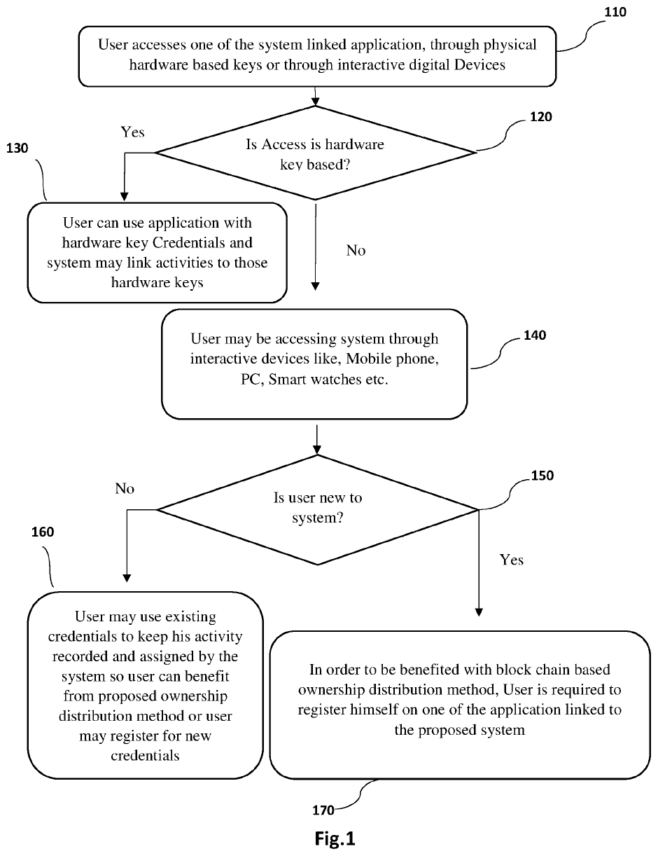

(640) Time Stamp is the issuance time of cryptographic ownership token (COT). In FIG. 1 it is illustrated that user can access the digital application through hardware based key cards or hardware and if user is not already registered to the system, user may need to register to be benefited with block chain based ownership distribution system and method. The Block chain technology based ownership distribution system and method may be implemented to single digital application or group of digital applications. For accessibility and logging, the group of applications may share same credentials interchangeably. User may register to one application and can also login other applications with the same accessibility credentials linked to the system. User can also link single cryptographic address generated for block chain system to multiple system linked applications, so usage reward of multiple applications those are the cryptographic ownership tokens are issued to single common address.

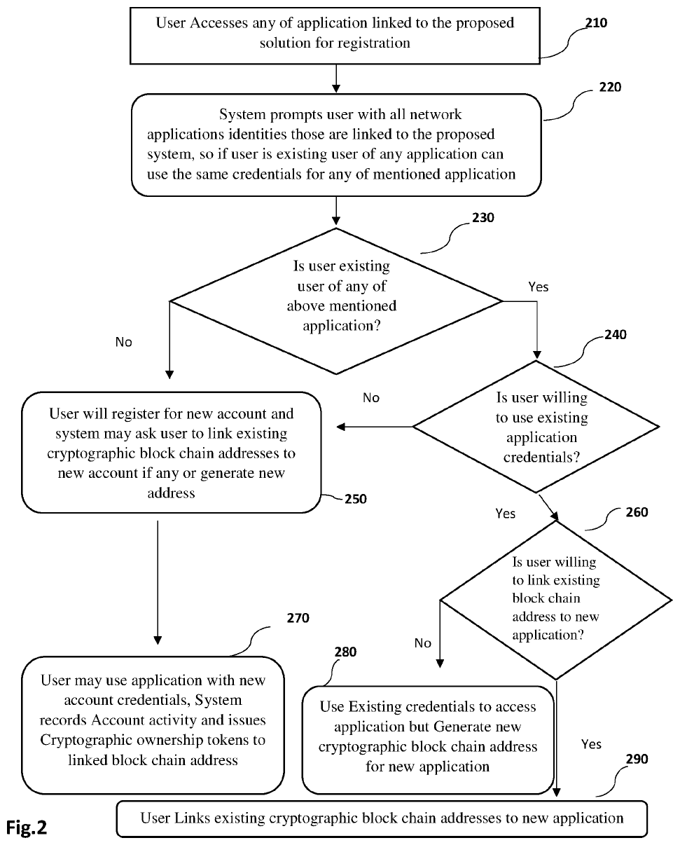

In FIG. 2 (210) for registration user accesses any of digital application operating under the proposed invention, (220) during registration session the accessed application may display identities of all other applications so that if user is already registered to any one of them may use the existing credentials to login. (240) if user is existing user of any of application linked to the system, user may decide whether to use existing credentials or generate new. (260) Here user is existing user of other application belonging to system linked applications and to login to new application user uses the existing credentials. System may allow user to use existing cryptographic public address for new application that is already linked to login credentials or user can link other cryptographic address for new application. In (250) user registers to application with new credentials, here system may ask user to link existing cryptographic address supported by system or generate new and link.

System application may allow user to create unlimited accounts and user may be able to generate, link unlink any number of system supported cryptographic address to any account at any time. System may support machine based activity recording and reward distribution, where specific machine is treated as single application account, these types of accounts are linked to devices and may only be accessible from specific linked machines.

For issuance of Cryptographic ownership tokens, Block chain system may only need valid public address, private key may not be required by block chain network for issuances of cryptographic ownership tokens except to process transfer of tokens from one address to another.

User may be able to use application without linking any cryptographic address, System may not be able to issue Cryptographic ownership token (COT) to that digital application account as there is no cryptographic address linked with digital application account. System may hold issuance till cryptographic address is linked with the account and once address is linked with the account previous issues may be made anytime in portions or at once. Application digital account with no block chain address linked may be able to see the balance of issuances on hold related to that specific account or in whole pending issuances.

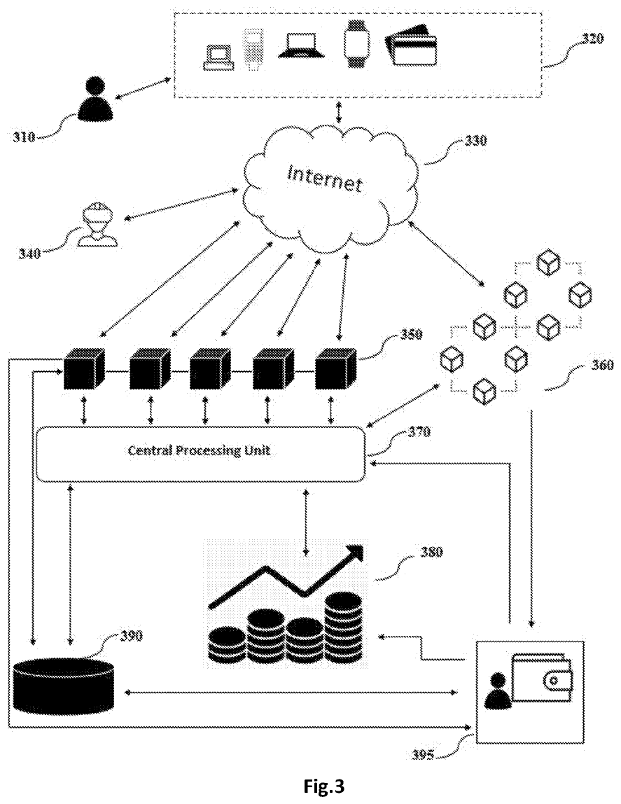

In FIG. 3 user (310,340) uses digital application, operating under Block chain technology based ownership distribution system and method, over an internet through any digital interactive device (310,340). The digital application units (350) are complete hardware and software based independent application units. During logged in session, when user uses application user session is recorded by every application unit against registered user digital account. Preferably, each digital application unit is intelligent enough to calculate digital application profitability based on activities conducted through application, for example, in digital application, activities are divided and defined into revenue and expenses and digital applications are able to recognize and list revenue based activities and expenses separately along with the financial values. Digital application units may be able to calculate profitability at any time interval. Digital application units may be able to apportion and assign the profitability to each digital account. Any of profitability linked to non-logged in session may be apportioned and distributed proportionally to log in session accounts or may be assigned to orphan account or address that is specifically dedicated to charitable cause. After digital application units have calculated profitability and have linked the profitability portion to every Digital account, the units may forward this information to central processing unit (370) along with digital account related information that may contain cryptographic public address for block chain system.

After central processing unit (370) receives the calculated profitability and assignment to digital accounts, information sent by digital application units, the central processing unit may use that information, and compile the list of request of issuance of Cryptographic ownership tokens (COTS) for block chain network (360), Central processing unit broadcasts that list with number of tokens to be issued against each cryptographic address, After receiving the request block chain may process the request and make new block containing new issuances of Cryptographic ownership tokens against provided addresses. Central processing unit may be able to provide the information to digital accounts and application units that when and how much issuances are going to be made in total or for particular account.

Central processing unit (370) may be able to forward request to block chain network at any set time interval at any frequency. The request of new issuance from central processing unit may be sequential or batched processed.

Block chain network (360) may represent single or multiple block chain networks.

Block chain network (360) may be able to add any number of new blocks at any frequency with any set time interval and with any number of transactions.

Block chain network (360) may be single node or may comprise any number of multi nodes.

Block chain network (360) may be centralized, decentralized, public, private, permissioned or permission less, But most preferably for security reasons block chain network cores may be configured to honor any update request from only authorized central processing Unit.

To ensure security and to prevent unauthorized broadcasting of update requests on block chain network, Block chain network core may have hidden symmetric cryptographic key or keys related to central processing unit from whom the update request is to be honored. And when Block chain network receives update request from central processing unit over secure network, the request also contains the hidden cryptographic key for validation of transaction. For request authentication, Key provided may be compared with key required for request authentication, if successful, request is honored. The key provided may be of one time use and each transaction need to contain unique cryptographic key. The key provided may also be time bound, valid for specific time or time interval. For further security the block chain network may be machine address bound or IP address bound from where only the block chain cores may receive the request for further processing.

System may not store cryptographic transaction requests symmetric cryptographic validation keys at central processing unit (370) or at block chain network cores (360), but both central processing unit and block chain network may generate transaction specific keys programmatically so valid key generated by central processing unit matches the key expected and generated by block chain network cores.

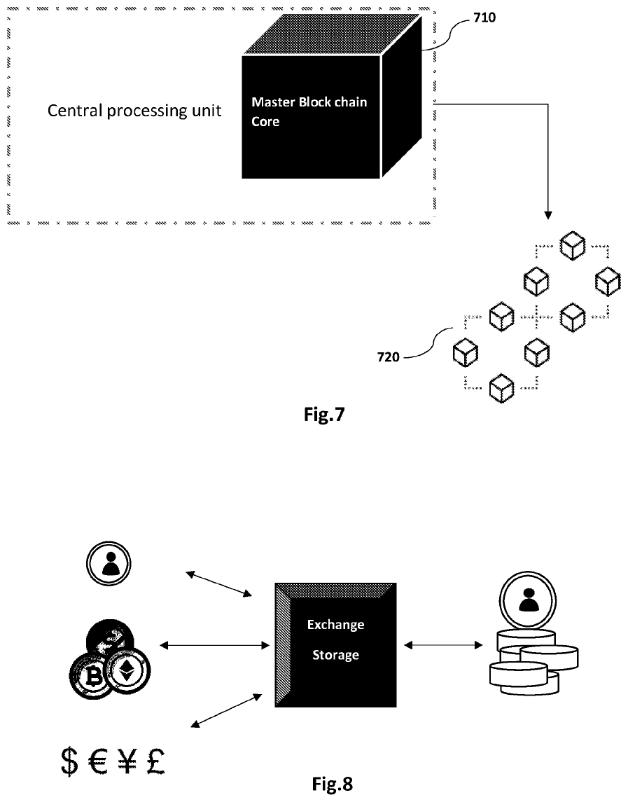

To improve security, Block chain network may operate under master slave relationship similar to as shown in FIG. 7. Where (710) Master block chain core is operating at same network or most preferably the same machine or within same environment where central processing unit is operating, so the instructions for block chain updates are not received from any external source. Once Master block chain core makes any change, the change may be unilaterally updated to slave Block chain cores (720) with or without any delay. In Master slave relationship the slave nodes will get updates from Master. Slave nodes may not be able to send any updates or changes to master node.

Digital application units (350) may be able to operate completely independent, where each unit may have their own processing unit, may be able to calculate Digital application profit, apportion and allocate profits to application digital accounts, compile and send request for issuance of cryptographic ownership tokens (COTs) at their own to their own linked block chain network, Here digital application units may not require to send any information to central processing unit. Here every block chain network linked to Digital application unit may be able to issue unique cryptographic ownership tokens (COTs). Digital application unit may be able to be linked, unlinked to any cryptographic ownership tokens block chain network.

(395) Represents crypto wallet that can be a single crypto wallet or multiple crypto wallets. Crypto wallet may be of hot, cold, hardware, desktop, mobile, web based or of any type. Preferably the proposed system may provide any of these types of crypto wallets. So user can store and transact crypto assets. To access, manage cryptographic ownership tokens issued by block chain network crypto wallets may be required. Crypto wallets User may be able to see the balance of cryptographic ownership tokens, can receive and transfer tokens (COTs) to and from other addresses, can generate unlimited number of new cryptographic addresses and can link, unlink, unlimited number of cryptographic addresses, can link and trade cryptographic ownership tokens with cryptographic ownership tokens exchange (380), can link and unlink wallet to any digital application.

User may able to generate unlimited cryptographic keys like one shown in FIG. 5 During, before or after registering to any Digital application. Preferably the system operating under Block chain technology based ownership distribution system and method may facilitate user to generate these cryptographic keys but system may also allow user to use third party key generators.

Generally at the time of registration to any digital application or after, for issuance of cryptographic ownership tokens (COTS), user may only require to link Public address or Public key to registered digital account. This public address linked to account may only be stored in system database or databases, so on the time of new cryptographic ownership tokens issuance request the public address linked to digital application account is forwarded to block chain network. A single digital application may have unlimited number of cryptographic addresses linked to one account at different times but preferably, at same time system may not allow more than one active public address linked to digital application. User may activate any public address provided or linked to digital application but mutually exclusively, which may deactivate any other active address linked to digital application account. A system application may inform users when next request for issuance for cryptographic ownership tokens is to be made and the time when user may not able to make any changes to public cryptographic address linked to application.

In Block chain technology based ownership distribution system and method in digital eco system, system may provide web based crypto wallet. This web based crypto wallet may be operating as an independent application or is inbuilt with every or any digital application. User may be able to link single cryptographic public address to multiple digital applications for issuance of cryptographic ownership tokens (COTs) and may also be able to link multiple different addresses linked to different applications to single crypto wallet. User may be required to provide valid wallet address while accessing web crypto wallet or the time of any transfer or transaction. Web crypto wallets may allow user to generate, add, remove, public and private keys. For secure access, to digital applications or crypto wallet, system may further support and provide different authentication methods like biometric authentication, Transaction authentication, Multi-factor Authentication, out-of-band authentication.

Web based crypto wallet may be less secure as keys are stored on network based database or databases, But in the event of keys lost user may be able to recover those keys only for the wallets created through strong validation accounts, like accounts opened with ID based verification.

FIG. 3 (380) represents Cryptographic ownership tokens trading exchange, this may be a single exchange unit or multiple exchange units, Cryptographic ownership tokens exchange will only list cryptographic ownership tokens those are generated by Block chain technology based ownership distribution method, Here user can buy sell cryptographic ownership tokens (COTS) against any available exchangeable crypto or Fiat currency. Trading exchange may allow user to exchange different cryptographic ownership tokens directly. This Cryptographic ownership tokens exchange may list any number of different cryptographic ownership tokens type. Users may be able to trade on cryptographic ownership tokens exchange with any of online crypto wallets provided by Block chain technology based ownership distribution system and method in digital eco system. If user is not previously registered to any of digital application, for trade, user may directly register to exchange. Exchange platform or wallet trade section may provide information such as list of all cryptographic ownership tokens that user can buy, sell and exchange along with current time buy, sell and exchange prices of cryptographic ownership tokens in any supported fiat, crypto currency or against other cryptographic ownership tokens. User willing to purchase any available cryptographic ownership tokens (COTs) may require to have deposits in exchange linked accounts or may start trade with any of (COTs) that is issued to user addresses by Block chain technology based ownership distribution system and method. User willing to sell any of cryptographic ownership token (COT) may set selling price at exchange interactive application or platform and exchange system may lock the position. During position is locked now user willing to sell may not be able to transfer position locked cryptographic ownership tokens (COTS) to any other cryptographic address unless user unlocks the locked position by withdrawing or cancelling the selling intent. Exchange system may allow user to unlock locked position so user may be able to cancel the selling request. While exchange locks the sell position, this is notified and recorded to request update forwarding unit, Unit like one shown in (370), by this when user tries to transfer position locked coins to any other address the request is rejected and is not updated by block chain network as coins are locked for sale.

For further clarity a simple example is presented, It is assumed that user A has single cryptographic address, User A possess 10 XYZ cryptographic ownership tokens (COTs) linked to single address, User A willing to sell 2 XYZ tokens, User A sets selling price for each COTs and submit sell request to cryptographic ownership tokens trading exchange, when exchange receives the sell request, exchange lists those tokens on trading exchange available for sale with sale price, At the same time or before listing, exchange may notify this sale request to block chain request processing and forwarding unit, Request processing and forwarding unit may be well informed about total cryptographic ownership tokens linked to single address. User A may be able to transfer 8 XYZ cryptographic ownership tokens to other addresses and block chain may update those transfers, After User A has transferred 8 XYZ COTs to other addresses only 2 XYZ cryptographic ownership tokens are left those 2 are locked for sale, When User A makes any further request for transfer, the request forwarding unit rejects that transfer request as remaining 2 XYZ COTs are reserved for sale. On successful sale of remaining 2 XYZ cryptographic ownership tokens trading exchange may forward this sale transaction information to Central Processing Unit (370) so the unit sends transfer request to new address to block chain network.

Exchange system may be able to lock tokens for sale specifically by token identifier (610).

Any successful transaction forwarded by exchange may be reflected on block chain network, trading exchange may forward transaction information to Central processing unit (370) in batches or in sequential order.

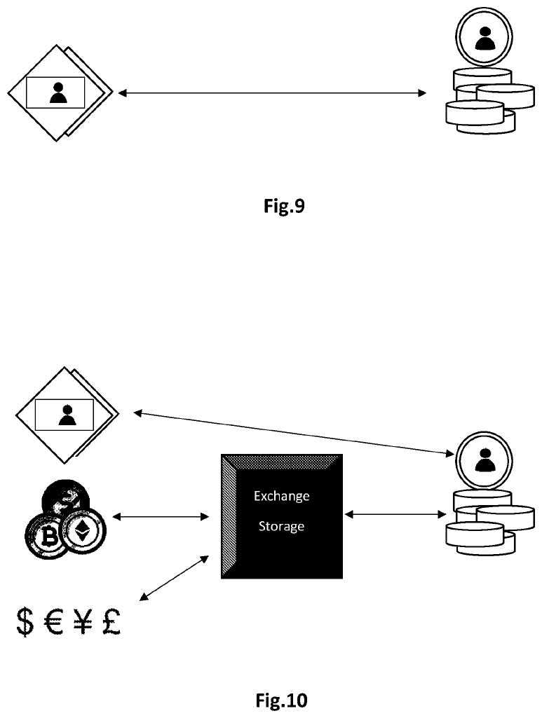

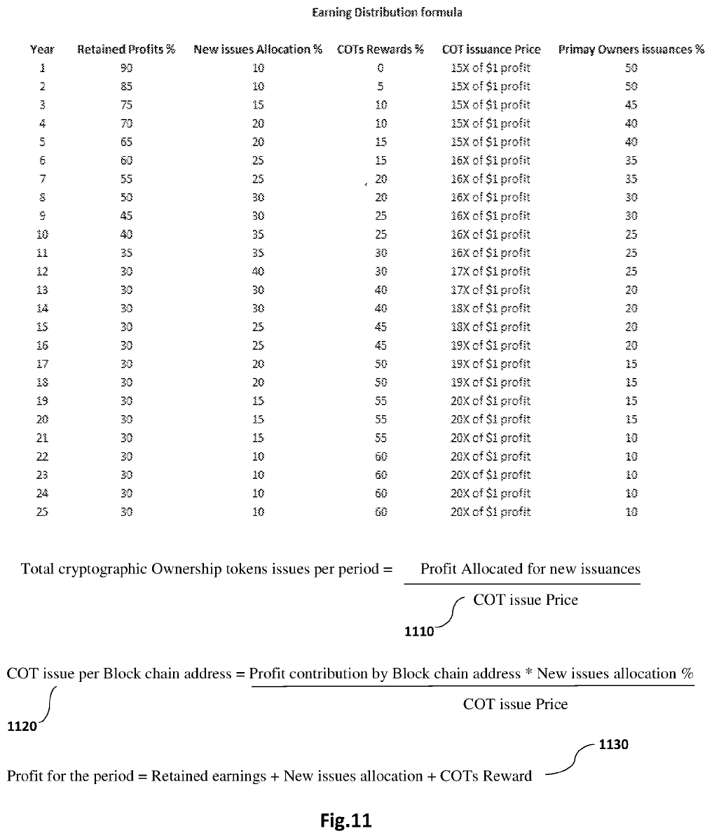

Exchange may operate as custodian, non-custodian or combination of both relationship, example shown in FIG. 8, FIG. 9 and FIG. 10.

Exchange operating as custodian, FIG. 8, where every deposits by user in terms of Fiat currency, crypto currency or cryptographic ownership tokens may be held in account or accounts belonging to cryptographic ownership tokens (COTs) trading exchange, trading exchange system may keep record of these deposits against every depositor, so user may utilize those deposits for trade and are also available for withdrawals.

Pure non-custodian exchange (FIG. 9) operation may happen when user is exchanging one cryptographic ownership token against another cryptographic ownership token type and all transfer and issuance of listed cryptographic ownership token happens through central processing unit where exchange can send information to lock the position, In this type user may not be required to transfer cryptographic ownership tokens to exchange account or addresses and exchange storage is not required, User may exchange directly the cryptographic ownership tokens listed on exchange without sending it to any intermediator address.

Hybrid custodian exchange operations are combination of custodian and non-custodian operating structure an example shown in FIG. 10, Here user makes deposits to exchange for assets those are related to third party and is not in complete control of exchange linked system. User may exchange Cryptographic ownership tokens without storing it to exchange storage as exchange linked system is in complete control of these cryptographic ownership tokens but for exchange of third party assets, like fiat currencies, crypto currencies and similar. User may need to deposit them to exchange related addresses or accounts.

Where user gets wallet from Digital application units or system linked application, where cryptographic ownership tokens are to be stored. These online wallets may have built in trade section in those wallets, where user may able to buy, sell and exchange cryptographic ownership tokens. User may also be able to buy, sell and exchange cryptographic ownership tokens against, crypto and Fiat currencies. To receive and deposit crypto currencies, trade section may require crypto currencies addresses belonging to user, system may facilitate user to link already existing addresses or generate new addresses and link it to trade account. For example user wants to sell 2 cryptographic ownership tokens against 2 bitcoins, to receive those bitcoins on successful sale system may require user to provide bitcoin address where user want to receive those coins, here user may provide existing bitcoin address or may generate new, trade section may allow user to generate new bitcoin addresses or use existing in order to receive sale consideration. Similarly, if user wants to sell cryptographic ownership tokens against FIAT currency, to receive sale consideration user may link FIAT currency bank account details with the system.

FIG. 3 (390) is representing Cryptographic ownership tokens (COTs) balance storage unit. Balance storage unit is a digital ledger system where all issued Cryptographic ownership tokens are listed against the holding addresses. Whenever request for transfer or issuance of cryptographic ownership token is processed and made by central processing unit or digital application unit to Block chain network, balance storage unit may also get the update.

FIG. 11 shows the proposed percentages and values that may be used by central processing unit or digital application units or any similar processing unit, to distribute profits and earnings. FIG. 3 (350)(370), The digital business units or central processing unit may calculate profits, by subtracting expenses from revenue earned, at any set interval, and may send request to block chain network for issuance of new cryptographic ownership tokens (COTs) and Cryptographic ownership token holder rewards. In Block chain technology based ownership distribution method in digital eco system the proposed system needs some references and formulae's on the basis the new COTs issuances and allocation is calculated and request is forwarded to block chain network. The system may be able to use any currency type for calculations but for simplicity and better understanding $ is used as an example.

The smallest unit of 1 cryptographic ownership token (COT) may be divisible to any decimal units and COTs issued to users of digital application may have voting or non-voting's rights attached. System may be able to calculate and distribute COTs at any interval with any frequency, system may be able to translate cryptographic ownership token and rewards in any currency type.

In FIG. 11 example, Year represents the interval at which profit is calculated and distributed.

In FIG. 11 example, Retained profits percentage is the amounts of profit that is not distributed and is preferably retained for re-investment and expansion.

In FIG. 11 example, new issuance Allocation is the percentage of profit that is allocated for issuance of new cryptographic ownership tokens (COTs).

In FIG. 11 example, Cots Rewards % is the profit percentage that will be distributed as reward to the holder of cryptographic ownership tokens, preferably, before any new issuances are made. Cots reward payment may be paid in any supported Fiat or crypto currency type.

In FIG. 11 example, COT issuance price is the price reference at which cryptographic ownership tokens will be issued, in FIG. 11. In year 1, one COT issuance requires $15 of profit and at year 25 for one COT issuance $20 profit is needed. System may be able to infer COT issuance price from weighted average market exchange price.

In FIG. 11 example, Primary owner's issuances % is the percentage of COTs those are issued to primary owners in relation to COTs issued to application users. For example in year one if 100 COTs are issued to application users, subsequently 50 COTs additionally may be issued to primary owners. Primary owners are those owners those have invested initially for development and operations of whole proposed system and with their titles the entities are incorporated with.

FIG. 11 (1110), is presenting the formula, that Central processing Unit (370) or any other processing unit responsible for calculation of new cryptographic ownership tokens to be issued may use in order to calculate total number of Cryptographic ownership tokens (COTs) to be issued for any particular time.

FIG. 11 (1120) is representing the formula that central processing unit (370) or any other processing unit that is responsible for sending request to block chain network for issuance of new cryptographic ownership tokens may use. A single block chain address may be linked to single digital application unit or user may link multiple digital applications to single block chain address, which means single Block chain address may have profit contribution share from user one digital application account usage or may have profit contribution share from multiple digital applications account.

For particular time, the different digital applications may use combine formula with same input variable, for example COT issue price system going to use is 15×, for single type cryptographic ownership tokens (COTs) block chain network or even for independent calculation of cryptographic ownership distribution tokens for different digital applications Block chain networks.

The term profit is used as a reference, whereas Block chain technology based ownership distribution method in digital eco system may be applied to Digital application entities those are not profiting and new issuances of COTs may be made by using revenues as a reference instead of profits.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms a, an, etc. Do not denote a limitation of quantity, but rather denote the presence of at least one of the referenced item.

Thus the scope of the invention should be determined by the appended claims and their legal equivalents, and not by the examples given.

I claim:

1. A processor implemented system and method of ownership distribution over block chain network to digital accounts linked to digital applications, wherein the method comprises: Recording, storing, activities of digital accounts through digital applications by digital application units, translating those activities into revenue streams, assigning profit contribution by digital accounts to digital accounts, sending requests for issuance of cryptographic ownership distribution tokens to block chain network for block chain addresses linked to digital application accounts.

2. The method of claim 1 where processing unit compiles the list of block chain addresses with numbers of cryptographic ownership tokens to be issued, before forwarding request to block chain network.

3. The method of claim 1 wherein for issuance of cryptographic ownership tokens single block chain address is linked to multiple digital application accounts.

4. The method of claim 1 wherein for issuance of cryptographic ownership tokens single block chain address is linked to multiple digital applications accounts.

5. The method of claim 1 wherein for issuance of cryptographic ownership tokens multiple digital applications are linked to single block chain network type.

6. The method of claim 1 wherein the time of issuance of cryptographic ownership tokens a single block chain address is linked to single application account.

7. The method of claim 1 wherein the time of issuance of cryptographic ownership tokens multiple block chain addresses are linked to single application account and system is guided the proportion of issuance of cryptographic ownership tokens to be made to each address.

8. The method of claim 1 wherein cryptographic ownership tokens are held for issuance for digital accounts with no block chain address linked.

9. The method of claim 1 wherein every digital application account with no block chain address linked can see the balance of on hold cryptographic ownership tokens.

10. The method of claim 1 wherein cryptographic ownership tokens held for issuance are issued any time after cryptographic address is linked to digital application account.

11. The method of claim 1 wherein digital application non logged in activity based profit is apportioned and distributed proportionally to log in session based digital application accounts.

12. The method of claim 1 wherein public block chain network honors the request received from authorized processing unit only.

13. The method further comprises; A digital exchange unit where only cryptographic ownership tokens are listed and exchanged.

14. The method of claim 13 wherein cryptographic ownership tokens are not deposited to exchange account and are listed for sale are locked by exchange by notifying the position lock to block chain request processing and forwarding unit.

15. The method of claim 13 where exchange system locks cryptographic owner ship tokens for sale specifically by token identifier.

16. The method of claim 13 where one type of cryptographic ownership tokens are exchanged against another type of cryptographic ownership tokens.
